(19) United States
(12) Patent Application Publication
(10) Pub. No.: US 2024/0313656 A1
(43) Pub. Date: Sep. 19, 2024

(54) BIAS GENERATION FOR POWER CONVERTER

(71) Applicant: TEXAS INSTRUMENTS INCORPORATED, Dallas, TX (US)

(72) Inventors: Saad PERVAIZ, Tyler, TX (US); Johan STRYDOM, Saratoga, CA (US); Michael LUEDERS, Freising (DE); Laszlo BALOGH, Merrimack, NH (US)

(21) Appl. No.: 18/184,913

(22) Filed: Mar. 16, 2023

(51) Int. Cl. H02M 3/335; H02M 1/08

(52) U.S. Cl. CPC H02M 3/33507; H02M 1/08

(57) ABSTRACT

An apparatus includes: a first transistor coupled between a primary-side terminal and a bias terminal, the first transistor having a first control terminal; a second transistor coupled between the bias terminal and a ground terminal, the second transistor having a second control terminal; and a control circuit having a control input, a reference input, and first and second control outputs, the control input coupled to the bias terminal, the first control output coupled to the first control terminal, the second control output coupled to the second control terminal, and the control circuit configured to provide first and second control signals having a same switching frequency at the respective first and second control outputs responsive to a first voltage at the control input and a second voltage at the reference input.

### CROSS REFERENCE TO RELATED APPLICATION

The present application is related to: U.S. Provisional Application No. ______, titled “Bias Generation For Power Converter”, Attorney Docket number T102350US01, filed on Mar. 16, 2023, which is hereby incorporated by reference in its entirety.

### BACKGROUND

A power converter can transfer power from a power source to a load. As part of power transfer, the power converter can also convert between an alternating current (AC) voltage and a direct current (DC) voltage (e.g., as an off-line converter) or between different DC voltages. The power converter can also regulate the output voltage to the load at a target voltage. A power converter may include various control circuits that control the operation of the power converter, and those control circuits also receive power from the power source.

### SUMMARY

In an example, an apparatus includes: a transistor coupled between a power converter bias terminal and a ground terminal, the transistor having a control terminal; a first driver circuit having a first driver input and a first driver output; a second driver circuit having a second driver input and a second driver output, the second driver output coupled to the control terminal; and a control circuit having a control input, a reference input, and first and second control outputs. The control input is coupled to the power converter bias terminal. The first control output is coupled to the first driver input. The second control output is coupled to the second driver input. The control circuit is configured to provide first and second control signals having a same switching frequency at the respective first and second control outputs responsive to a first voltage at the control input and a second voltage at the reference input.

In another example, an apparatus includes: a first transistor coupled between a power converter switching terminal and a bias terminal, the first transistor having a first control terminal; a second transistor coupled between the bias terminal and a ground terminal, the second transistor having a second control terminal; a first driver circuit having a first driver input and a first driver output, the first driver output coupled to the first control terminal; a second driver circuit having a second driver input and a second driver output, the second driver output coupled to the second control terminal; and a control circuit having a control input, a reference input, and first and second control outputs. The control input is coupled to the bias terminal. The first control output is coupled to the first driver input. The second control output is coupled to the second driver input. The control circuit is configured to provide first and second control signals having a same switching frequency at the respective first and second control outputs responsive to a first voltage at the control input and a second voltage at the reference input.

In yet another example, a method includes: determining an on-time of a power converter based on an output voltage of the power converter and a first reference voltage; determining an offset interval based on a bias voltage and a second reference voltage; within the on-time and the offset interval, connecting a switching terminal of the power converter to a capacitor, and disconnecting the switching terminal from a ground terminal, to generate the bias voltage across the capacitor; and within the on-time and outside the offset interval, connecting the switching terminal to the ground terminal.

### BRIEF DESCRIPTION OF THE DRAWINGS

FIG. 1A and FIG. 1B are schematic diagrams showing examples of a power conversion system including a bias generation circuit.

FIG. 2 is a schematic diagram illustrating example internal components of a power conversion system.

FIG. 3 is a schematic diagram illustrating example internal components of a power conversion system.

FIG. 4 is a graph representing operations of an example bias generation circuit.

FIG. 5 is a graph representing operations of an example bias generation circuit.

FIG. 6 is a schematic diagram illustrating example internal components of the power conversion system of FIGS. 1A, 1B, and FIG. 2.

FIG. 7 is a flowchart illustrating an example method of controlling a power converter.

### DETAILED DESCRIPTION

The same reference numbers or other reference designators are used in the drawings to designate the same or similar features. Such features may be the same or similar either by function and/or structure.

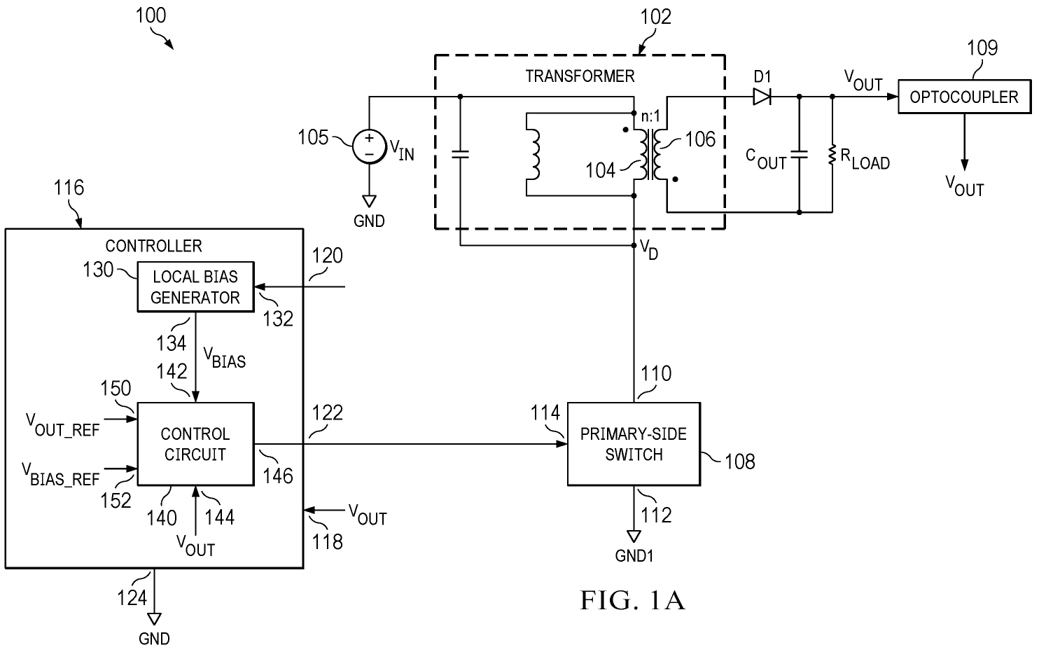

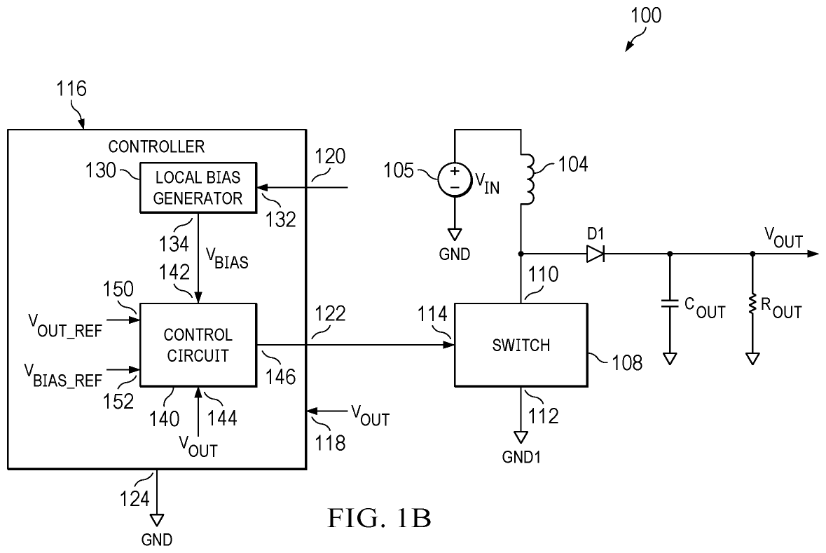

FIG. 1A and FIG. 1B are schematics that illustrate examples of a power conversion system. The example power conversion system includes a power converter 100 and a controller 116. In FIG. 1A, power converter 100 can include a flyback converter including a transformer 102. Transformer 102 has a primary winding 104 and a secondary winding 106. The primary winding 104 is coupled between a power source 105 that provides an input voltage V_{IN} and a primary-side switch 108. The primary-side switch 108 has a first terminal 110, a second terminal 112, and control terminal 114, and the primary winding 104 is coupled between power source 105 and first terminal 110. In some examples, first terminal 110 can be a switching terminal for power converter 100. The second terminal 112 can be coupled to ground. Also, the secondary winding 106 is coupled between a diode D1 and a capacitor C_{OUT}. Power converter 100 can provide an output voltage V_{OUT} across capacitor C_{OUT}. The power conversion system may include an optocoupler 109 coupled to the output of power converter 100 to sense the output voltage V_{OUT}.

The power conversion system also includes controller 116. The controller 116 has a first input 118, a second input 120, outputs 122, and a ground terminal 124. In some examples, the controller 116 includes a bias generator circuit 130 and a control circuit 140. The bias generator circuit has an input 132 and an output 134. The control circuit 140 has first input 142, a second input 144, and outputs 146. The bias generator circuit 130 and/or the control circuit 140 may also have a ground terminal (not shown). In some examples, the controller 116 and the primary-side switch 108 can be on a same semiconductor die. In some examples, primary-side switch 108 (or part of it) and the controller 116 can be on different semiconductor dies.

In some examples, the first input 118 of the controller 116 receives V_{OUT}. For example, V_{OUT} may be received via an optocoupler between the first side of the secondary winding 106 and the first input 118 of the controller 116. In some examples, the first input 118 may be coupled to the first terminal 110 (switching terminal) and receives a voltage indicative of V_{OUT} or other voltages. The second input 120 of the controller 116 receives power from the second side of the primary winding 104. The outputs 122 of the controller 116 are coupled to the control terminals 114 of the primary-side switch 108. The ground terminal 124 of the controller 116 is coupled to ground.

The input 132 of the bias generator circuit 130 is coupled to the second input 120 of the controller 116. The output 134 of the bias generator circuit 130 is coupled to the first input 142 of the control circuit 140. Bias generator circuit 130 can supply a bias signal, which includes a V_{BIAS} voltage and a bias current, to provide power to control circuit 140. The second input 144 of the control circuit 140 is coupled to the first input 118 of the controller 116. The outputs 146 of the control circuit 140 is coupled to the outputs 122 of the controller 116. The control circuit 140 also has a third input 150 to receive a reference output voltage (V_{OUT_REF}), and a fourth input 152 to receive a reference bias voltage (V_{BIAS_REF}).

In operation, the flyback converter can control the transfer of power from power source 105 to the load (e.g., R_{LOAD}) via the switching of primary-side switch 108. Specifically, when primary-side switch 108 is turned on, a current flow through primary winding 104 and primary-side switch 108 to ground. The primary side current increases with time, with the rate of increase based on the input voltage across primary winding 104 and the inductance of primary winding 104, and magnetic energy is stored in transformer 102. When primary-side switch 108 is turned off, the transformer voltage reverses, and the magnetic energy stored in transformer 102 is delivered via the secondary winding 106 to the output capacitor and the load. The secondary side current decreases with time as the stored magnetic energy decreases.

Control circuit 140 can provide control signal(s) to control the switching of primary-side switch 108. The duty cycle of the control signal, together with a turn ratio between the primary and second side windings and the inductance of the primary side winding 104, can set a ratio between the output voltage and the input voltage, as well as the amount of power transferred from power source 105 to the load (e.g., RLOAD). Control circuit 140 can regulate the output voltage at a target (e.g., reference output voltage V_{OUT_REF}) by modulating the duty cycle of the control signal. Control circuit 140 can control the flyback converter to operate in various modes of operation, such as discontinuous conduction mode (DCM), transition mode (TM), quasi resonant mode (QR), and continuous conduction mode (CCM). In DCM, TM, and QR operations, the primary side current increases from zero to reach a first peak value, and the secondary side current decreases from a second peak value to zero. In CCM operation, the primary side current increases from a first non-zero initial value to reach a first peak value, and the secondary side current decreases from a second peak value to a second non-zero final value. As to be described below, the control circuit 140 can also set the timing of the control signals to convert magnetization current that charges the leakage inductance of the primary-side winding, and/or charge stored in the parasitic capacitances of the primary-side switch 108, to generate V_{BIAS}.

FIG. 1B illustrates another example power conversion system including power converter 100 and controller 116. In FIG. 1B, power converter 100 can be a boost converter including inductor 104 and switch 108, where inductor 104 is coupled between power source 105 and switch 108. Switch 108 has terminals 110 and 112, and terminal 110 can be a switching terminal for power converter 100. Inductor 104 is also electrically coupled to diode D1 and capacitor C_{OUT}. The boost converter can control the transfer of power from power source 105 to load via the switching of switch 108. When switch 108 is turned on, current flows through inductor 104 and switch 108. The current increases with time, with the rate of increase based on the input voltage across inductor 104 and the inductance of inductor 104, and magnetic energy is stored in inductor 104. When switch 108 is turned off, the magnetic energy stored in inductor 104 is transferred to the load and output capacitor. The inductor current decreases with time as the magnetic energy decreases. In FIG. 1B, the control circuit 140 can also provide a control signal to switch 108, and set a duty cycle of the control signal based on a ratio between the output voltage and the input voltage. Control circuit 140 can also operate the boost converter in various modes, such as DCM, TM, and CCM modes of operations. Also, as to be described below, the control circuit 140 can also set the timing of the control signals to convert magnetization current that charges the leakage inductance of inductor 104, and/or charge stored in the parasitic capacitances of the switch 108, to generate V_{BIAS}.

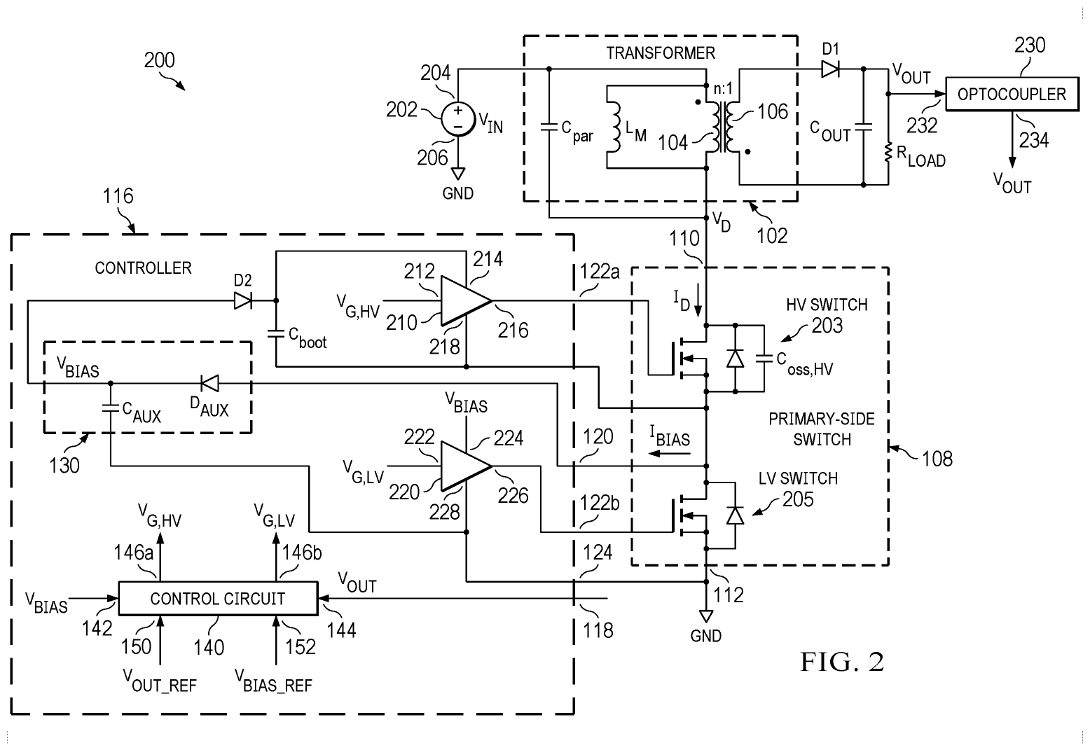

FIG. 2 is a schematic diagram showing a power conversion system 200 in accordance with an example embodiment. In the example of FIG. 2, the power conversion system 200 includes a power supply 202, the transformer 102, a diode D1, an output capacitor (C_{OUT}), a load (R_{LOAD}), and can be an example of power conversion system of FIG. 1A including a flyback converter. In some examples (not shown in FIG. 2), power conversion system 200 can also include a boost converter and can be an example of power conversion system of FIG. 1b.

In FIG. 2, the switch 108 (primary-side switch 108 of FIG. 1A, switch 108 of FIG. 1B) includes a high-voltage (HV) switch 203 and a low-voltage (LV) switch 205 coupled in series between terminals 110 and 112. Each of HV switch 203 and LV switch 205 can include a transistor. The HV switch 203 and the LV switch 205 can form a cascode structure. In some examples, HV switch 203 and LV switch 205 can be on different semiconductor dies. For example, HV switch 203 can be on a first semiconductor die having a Silicon Carbide substrate, and LV switch 205 can be on a second semiconductor die having a Silicon substrate. In some embodiments, HV switch 203 may include a transistor device that can tolerate a relatively high voltage (e.g., 600 V or above), and LV switch 205 may include a transistor device that operate under a relatively low voltage (e.g., 20 V or below).

In FIG. 2, the HV switch 203 includes a parasitic capacitance (C_{OSS,HV}). To control the HV switch 203, the system 200 includes an optocoupler 230 and controller 116, which includes the bias generator circuit 130 and the control circuit 140. In some examples, the driver circuitry for the HV switch 203 includes a first driver circuit 210, a diode D2, and a capacitor (C_{boot}) in the arrangement shown in FIG. 2. In some examples, the bias generator circuit 130 includes a diode D_{AUX}, a capacitor C_{AUX} in the arrangement shown in FIG. 2. As to be described below, C_{AUX} can store charge transferred from various parasitic capacitance of power converter 100 through the switching of HV switch 203 and LV switch to generate the V_{BIAS} voltage.

As shown, the power supply 202 has a first side 204 and a second side 206. The transformer 102 includes the primary winding 104 and the secondary winding 106. In the example of FIG. 2, a parasitic capacitance (Cₚₐᵣ) and a parasitic inductance (L_{M}) in parallel with the primary winding 104 is represented on the primary-side of the transformer 102. In a case of a boost converter, inductor 104 can also have Cₚₐᵣ and L_{M}. The HV switch 203 has a first terminal, a second terminal, and a control terminal. In FIG. 2, each of Cₚₐᵣ, L_{M}, the primary winding 104, the secondary winding 106, C_{OUT}, and R_{LOAD} has a respective first side and a respective second side. The diode D1 has an anode and a cathode, The optocoupler 230 has an input 232 and an output 234.

As shown, the controller 116 has the first input 118, the second input 120, the outputs 122a and 122b, and the ground terminal 124 described in FIG. 1. The control circuit 140 has the first input 142, the second input 144, and the outputs 146, including outputs 146a and 146b described in FIG. 1. In FIG. 2, the output 146a is a first output, and the output 146b is a second output. The LV switch 205 has a first terminal, a second terminal, and a control terminal. Each of D2 and D_{AUX} has a respective anode and a respective cathode. Each of C_{boot} and C_{AUX} has a respective first side and a respective second side. The first driver circuit 210 has a first input 212, a second input 214, an output 216, and a ground terminal 218. The second driver circuit 220 has a first input 222, a second input 224, an output 216, and a ground terminal 218.

In the example of FIG. 2, the first side 204 of the power supply 202 is coupled to the first side of the primary winding 104. The second side 206 of the power supply 202 is coupled to a ground terminal. The first sides of Cₚₐᵣ and L_{M} are coupled to the first side of the primary winding 104. The second sides of Cₚₐᵣ and L_{M} are coupled to the second side of the primary winding 104. The second side of the primary winding 104 is coupled to the first terminal of the HV switch 203. The first side of the secondary winding 106 is coupled to the anode of D1. The cathode of D1 is coupled to the first sides of C_{OUT} and R_{LOAD}. The second sides of C_{OUT} and R_{LOAD} are coupled to the second side of the secondary winding 106. The cathode of D1 is also coupled to the input 232 of the optocoupler 230. The output 234 of the optocoupler 230 is coupled to the first input 118 of the controller 116. The second input 120 of the controller 116 is coupled to the second terminal of the HV switch 203. The output 122a of the controller 116 is coupled to the control terminal of the HV switch 203. The output 122b of the controller 116 is coupled to the control terminal of the LV switch 205. The ground terminal 124 of the controller 116 is coupled to ground.

In the example of FIG. 2, the first input 142 of the control circuit 140A is coupled to the first side of C_{AUX}. The second input 144 of the control circuit 140A is coupled to the first input 118 of the controller 116. The first output 146a of the control circuit 140 is coupled to the first input 212 of the first driver circuit 210. The second output 146b of the control circuit 140 is coupled to the first input 222 of the second driver circuit 220.

The first terminal of the LV switch 205 is coupled to the second input 120 of controller 116. Herein, the second input 120 of the controller 116 is sometimes referred to as a bias terminal. The second terminal of the LV switch 205 is coupled to the ground terminal 124 of the controller 116. The control terminal of the LV switch 205 is coupled to the output 226 of the second driver circuit 220. The second input 224 of the second driver circuit 220 is coupled to the first side of C_{AUX}. The ground terminal 228 of the second driver circuit 220 is coupled to the ground terminal of the controller 116.

The anode of D_{AUX} is coupled to the second input 120 of the controller 116. The cathode of D_{AUX} is coupled to the first side of C_{AUX}. The anode of D2 is coupled to the first side of C_{AUX}. The cathode of D2 is coupled to the first side of C_{boot}. The second side of C_{boot} is coupled to the second input 120 of the controller 116. The second input 214 of the first driver circuit 210 is coupled to the first side of C_{boot}. The ground terminal 218 of the first driver circuit 210 is coupled to the second input 120 of the controller 116.

In FIG. 2, the transformer 102, diode D1, the HV switch 203, the LV switch 205, and the controller 116 operate as a flyback converter to provide V_{OUT} to R_{LOAD} responsive to V_{IN} and the operations of the HV switch 203. With the controller 116, the flyback converter includes an integrated bias generator to power the control circuit 140, the first driver circuit 210, and the second driver circuit 220 using primary-side energy. During operations of the flyback converter, the voltage at the second side of the primary winding 104 is V_{D}, and the current at the second side of the primary winding 104 is I_{D}. By operation of the LV switch 205 relative to the operation of the HV switch 203, V_{D} and I_{D} are used to generate V_{BIAS} to power the control circuit 140, the first driver circuit 210, and the second driver circuit 220.

In operation, the transformer 102 provides energy from the primary winding 104 to the secondary winding 106 responsive to V_{IN} and the operations of the HV switch 203. The energy provided to the second secondary 106 is used to charge C_{OUT} and provide V_{OUT} to R_{LOAD}. The optocoupler 230 is configured to: receive V_{OUT} at its input 232; and provide V_{OUT} or a related signal at its output 234.

During operations of the HV switch 203, V_{D} and I_{D} are used to generate a bias current (I_{BIAS}) at the second input 120 of the IC 112 responsive to operations of the HV switch 203 and the LV switch 205. I_{BIAS} is used to charge C_{AUX} via D_{AUX} to generate V_{BIAS}. The control circuit 140 is configured to: receive V_{BIAS} at its first input 142; receive V_{OUT} or a related signal at its second input 144; provide a first control signal (V_{G,HV}) at its first output 146a responsive to V_{OUT} and V_{BIAS}; and provide a second control signal (V_{G,LV}) at its second output 146b responsive to V_{OUT} and V_{BIAS}. The first driver circuit 210 is configured to: receive V_{G,HV} at its first input 212, receive the charge on C_{boot} at its second input 214; and provide a switch control signal to the HV switch 203 at its output 216 responsive to V_{G,HV} and the charge on C_{boot}. The second driver circuit 220 is configured to: receive V_{G,LV} at its first input 222, receive the charge on C_{AUX} (V_{BIAS}) at its second input 224; and provide a switch control signal to the LV switch 205 at its output 226 responsive to V_{G,LV} and V_{BIAS}.

As described above, the HV switch 203 and the LV switch 205 form a cascode structure. The cascode structure can be controlled by controller 116 to transfer charge from various parasitic capacitances of power converter 100 to C_{AUX} to generate a bias voltage V_{BIAS}, and to supporting the charging and discharging of inductor/primary side winding 104. Charge capture for V_{BIAS} generation using the cascode structure of system 200 may be performed in various ways. First, at least some of the parasitic charge Q_{OSS} stored in parasitic capacitance of the HV switch 203 can flow to C_{AUX} for V_{BIAS} generation at turn-off of the HV switch 203. Second, at least some of the parasitic charge Qₚₐᵣ stored in the parasitic capacitances of the transformer 102 (or inductor 104 of a boost converter) can flow to C_{AUX} for V_{BIAS} generation at turn-on of the HV switch 203. Third, I_{LM} magnetization inductor current (which may be programmable) may be diverted by HV switch 203 to charge C_{AUX} for V_{BIAS} generation.

Having HV switch 203 and the LV switch 205 to transfer parasitic charge and/or divert magnetization current to C_{AUX} for V_{BIAS} generation can provide various advantages. Specifically, the parasitic charge and magnetization current may represent part of the power/energy supplied by power source 105. The energy may have otherwise been lost during the switching of switch 104 if they are not diverted to C_{AUX} for V_{BIAS} generation. By capturing a part of the parasitic charge and magnetization current in C_{AUX}, and using them to supplying power to other circuits (e.g., control circuit 140) in the form of bias signal, the power loss of the power converter can be reduced. Moreover, such arrangements also reduce (or eliminate) the need for additional power from the power source for bias generation. All these can improve the efficiency of the power converter. Further, HV switch 203 and LV switch 205, as well as capacitor C_{AUX} and diode D_{AUX} and control circuit 140, can be integrated in the same integrated circuit, which can reduce the overall footprint of controller 116 and the power conversion system.

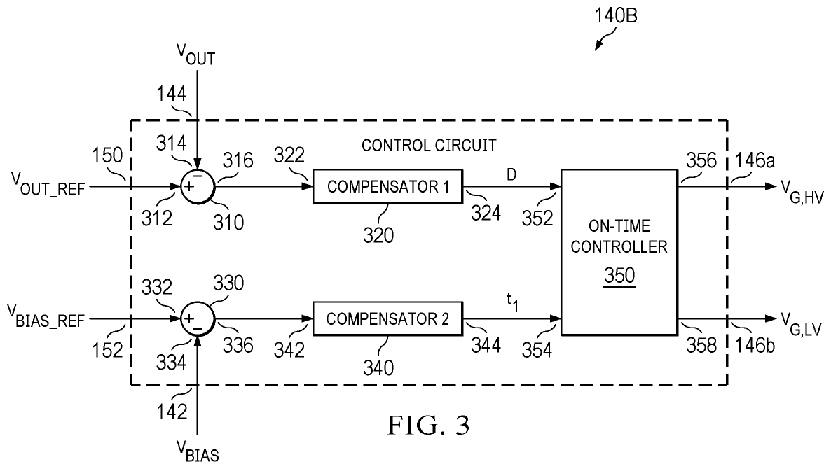

FIG. 3 is a diagram showing internal components of control circuit 140 in accordance with an example embodiment. As shown, the control circuit 140 has the first input 142, the second input 144, the third input 150, the fourth input 152, the first output 146, and the second output 146b described in FIGS. 1 and 2. The control circuit 140 includes a first comparison circuit 310, a first compensation circuit 320, a second comparison circuit 330, a second compensation circuit 340, and an on-time controller 350.

The first comparison circuit 310 has a first input 312, a second input 314, and an output 316. The first compensation circuit 320 has an input 322 and an output 324. The second comparison circuit 330 has a first input 332, a second input 334, and an output 336. The second compensation circuit 340 has an input 342 and an output 344. The on-time controller 350 has a first input 352, a second input 354, a first output 356, and a second output 358.

The first input 312 of the first comparison circuit 310 is coupled to the third input 150 to receive a target V_{OUT} (V_{OUT,REF}). The second input 314 of the first comparison circuit 310 is coupled to the second input 144 of the control circuit 140B. The output 316 of the first comparison circuit 310 is coupled to the input 322 of the first compensation circuit 320. The output 324 of the first compensation circuit 320 is coupled to the first input 352 of the on-time controller 350. The first input 332 of the second comparison circuit 330 is coupled to the fourth input 152 to receive a target V_{BIAS} (V_{BIAS,REF}). The second input 334 of the second comparison circuit 330 is coupled to the first input 142 of the control circuit 140B. The output 336 of the second comparison circuit 330 is coupled to the input 342 of the second compensation circuit 340. The output 344 of the second compensation circuit 340 is coupled to the second input 354 of the on-time controller 350. The first output 356 of the on-time controller 350 is coupled to the first output 146 of the control circuit 140B. The second output 358 of the on-time controller 350 is coupled to the second output 146b of the control circuit 140B.

In some examples, the first and second comparison circuits 310 and 330 operate as subtraction circuits and/or differential circuits. In such examples, the first comparison circuit 310 is configured to: receive V_{OUT,REF} at its first input 312; receive V_{OUT} at its second input 314; and provide a first subtraction result (e.g., the difference between V_{OUT,REF} and V_{OUT}) at its output 316 responsive to V_{OUT,REF} and V_{OUT}. The first compensation circuit 320 is configured to: receive the first subtraction result at its input 322; and provide a first compensation at its output 324 responsive to the first subtraction result. The second comparison circuit 330 is configured to: receive V_{BIAS,REF} at its first input 332; receive V_{BIAS} at its second input 334; and provide a second subtraction result the difference between V_{BIAS,REF} and V_{BIAS}) at its output 336 responsive to V_{BIAS,REF} and V_{BIAS}. The second compensation circuit 340 is configured to: receive the second subtraction result at its input 342; and provide a second compensation signal representing an offset interval (t₁) at its output 344 responsive to the second subtraction result. The duration of the offset interval can affect the duration in which the capacitor C_{AUX} is charged and the resulting V_{BIAS} voltage.

The on-time controller 350 is configured to: receive the first compensation signal at its first input 352; receive the second compensation signal at its second input 354; provide V_{G,HV} at its first output 356 responsive to the first compensation signal; and provide V_{G,LV} at its second output 358 responsive to the first compensation signal and the second compensation signal. In some examples, the first compensation signal is a duty-cycle (D) for the HV switch 203 or related adjustment signal. The second compensation signal is an offset interval (t₁) for the V_{G,LV} on-time relative to the V_{G,HV} on-time.

In some examples, the control circuit 140 is configured to generate V_{BIAS} based on a leading-edge control scheme. In other examples, the control circuit 140A is configured to generate V_{BIAS} based on a trailing-edge control scheme. In still other examples, the control circuit 140 is configured to generate V_{BIAS} based on a combined leading-edge and trailing-edge control scheme.

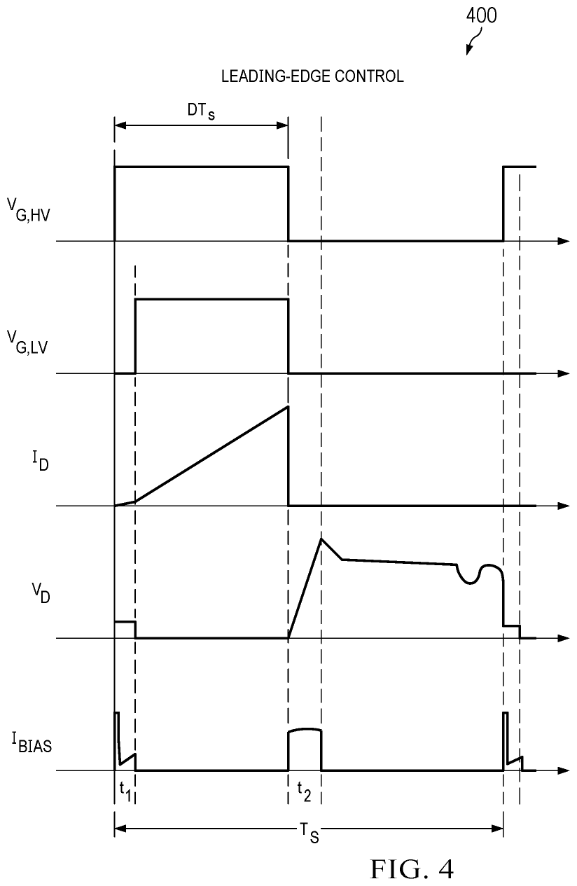

FIG. 4 is a graph 400 showing examples operations of a power converter in generating V_{BIAS}, such as a flyback converter in FIG. 1A or a boost converter in FIG. 1B under the control of control circuit 140. In the graph 400, a leading-edge control scheme for generating V_{BIAS} is represented using signals for V_{G,HV}, V_{G,LV}, I_{D}, V_{D}, I_{BIAS} as a function of time. As shown, each of V_{G,HV} and V_{G,LV} has an on-time, an off-time, and a switching cycle period (T_{S}). The duration of the on-time of V_{G,HV} is given as DT_{S}, where D is the duty-cycle. The control circuit 140 can set the duty-cycle can be based on a ratio between V_{OUT} and V_{IN} and, in a case of flyback converter, also based on a turn ratio between the primary winding 104 and the secondary winding 106. Accordingly, in FIG. 3, the control circuit 140 can set the duty cycle D based on a difference between V_{OUT} and V_{OUT,REF}, where V_{OUT,REF} can be a reference/target output voltage set based on a target ratio between Vₒᵤₜ and V_{IN}. In the example illustrated in FIG. 4, control circuit 140 can operate the power converter in DCM, TM, or QR (for a flyback converter) modes.

During the on-time of V_{G,HV}, the HV switch 203 is turned on/enabled, and HV switch 203 connects the switching terminal (coupled to primary winding/inductor 104) to diode D_{AUX} (and capacitor C_{AUX}). Also, during the off-time of V_{G,HV}, the HV switch 203 is turned off/disabled, and HV switch 203 disconnects the switching terminal from diode D_{AUX} (and capacitor C_{AUX}). Also, during the on-time of V_{G,LV}, the LV switch 205 is turned on/enabled, and during the off-time of V_{G,LV}, the LV switch 205 is turned off/disabled. The on-time for V_{G,LV} overlaps with the on-time for V_{G,HV}, but is delayed by the offset interval t₁. In other words, the leading edges for V_{G,LV} and V_{G,HV} are offset from each other by the offset interval (t₁). With the leading-edge control scheme, each T_{S} begins with an offset interval.

During the offset interval, V_{G,HV} is asserted (or having a high state or a logical one state), and V_{G,LV} is de-asserted (or having a low state, or a logical zero state), and HV switch 203 connects the switching terminal (coupled to primary winding/inductor 104) to diode D_{AUX} (and capacitor C_{AUX}). The magnetization inductor current I_{LM} can flow from primary winding/inductor 104 through HV switch 203 (as I_{D}) and diode D_{AUX} into capacitor C_{AUX}. Also, the parasitic capacitance Cₚₐᵣ of primary winding/inductor 104 also discharge, and the parasitic charge Qₚₐᵣ in Cₚₐᵣ can also flow to capacitor C_{AUX} via diode D_{AUX}. As charge accumulates at C_{AUX}, a voltage V_{BIAS} can develop across C_{AUX}. The duration of the offset interval t₁ can affect the amount of charge stored in C_{AUX} and the resulting V_{BIAS} voltage. Accordingly, the control circuit 140 can regulate V_{BIAS} at or around V_{BIAS,REF} by setting the duration of the offset interval t₁ based on a difference between V_{BIAS} and V_{BIAS,REF}.

After the offset interval, V_{G,HV} and V_{G,LV} are asserted together, which brings the voltage V_{D} to almost ground. This can be an on-time of the power converter, and the primary winding/inductor 104 can be charged to store magnetic energy. The current conducted by primary winding/inductor 104 (I_{D}) increases with time. V_{G,HV} and V_{G,LV} are subsequently de-asserted together for the durations of the off-times of V_{G,HV} and V_{G,LV} till the end of T_{S}. The off-times of V_{G,HV} and V_{G,LV} can represent an off-time of the power converter, in which primary winding/inductor 104 discharges and releases the stored magnetic energy.

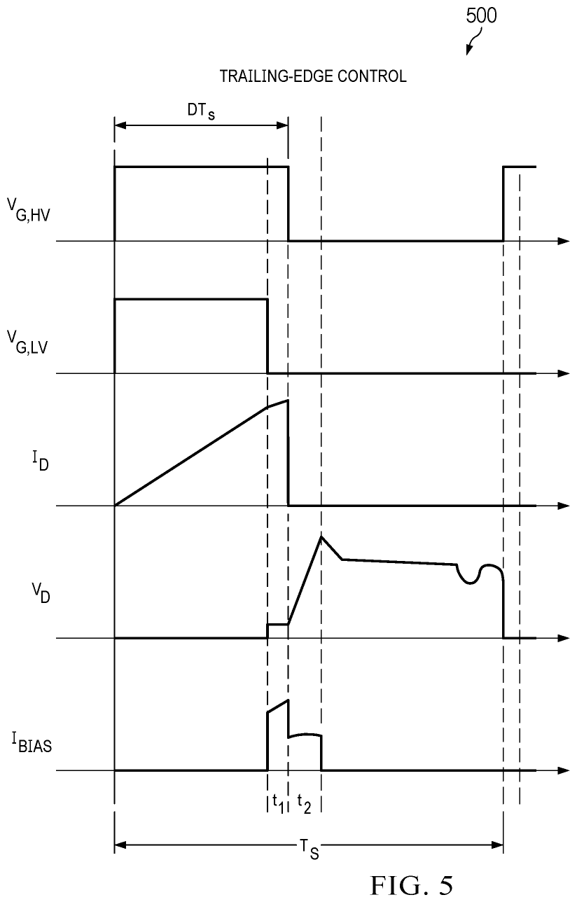

During a second interval (t₂) after V_{G,HV} and V_{G,LV} are de-asserted together, the parasitic charge Q_{OSS} stored in the parasitic capacitance of HV switch 203 can be transferred to C_{AUX} via D_{AUX}, and V_{BIAS} can further increase. After t₂, V_{G,HV} and V_{G,LV} stay de-asserted for the durations of the off-times of V_{G,HV} and V_{L,HV} till the end of T_{S}. At the end of T_{S}, the leading-edge control scheme is repeated. With a leading-edge control scheme, V_{BIAS} generation is based on: 1) Qₚₐᵣ energy capture and I_{LM} energy capture during t₁; 2) Q_{OSS} energy capture during t₂. In the example illustrated in FIG. 5, control circuit 140 can operate the power converter in DCM, TM, or QR (for a flyback converter) modes.

FIG. 5 is a graph 500 showing examples operations of a power converter in generating V_{BIAS}, such as a flyback converter in FIG. 1A or a boost converter in FIG. 1B under the control of control circuit 140. In the example illustrated in FIG. 5, control circuit 140 can operate the power converter in DCM, TM, or QR (for a flyback converter) modes.

In the graph 500, a trailing-edge control scheme for generating V_{BIAS} is represented using signals for V_{G,HV}, V_{G,LV}, I_{D}, V_{D}, I_{BIAS} as a function of time. Again, each of V_{G,HV} and V_{L,HV} has an on-time, an off-time, and a switching cycle period (T_{S}). The duration of the on-time of V_{G,HV} is given as DT_{S}, where D is the duty-cycle. The control circuit 140 can set the duty-cycle can be based on a ratio between V_{OUT} and V_{IN} and, in a case of flyback converter, also based on a turn ratio between the primary winding 104 and the secondary winding 106. With the trailing-edge control scheme, the on-time for V_{G,LV} overlaps with the on-time for V_{G,HV} with the on-time for V_{G,LV} ending before the on-time for V_{G,HV}. In other words, the trailing edges for V_{G,LV} and V_{G,HV} are offset from each other by the offset interval (t₁). In the trailing-edge control scheme, V_{G,HV} and V_{G,LV} are initially asserted together for each Tₛ, which corresponds to the on-time of the power converter and I_{D} ramps up as primary winding/inductor 104 stores magnetic energy.

During the offset interval, V_{G,HV} is asserted, V_{G,LV} is de-asserted. Primary winding/inductor 104 discharges and releases the stored magnetic energy. The magnetization current I_{LM} also flows from primary winding/inductor 104 through HV switch 203 and diode D_{AUX} to charge C_{AUX}, and V_{BIAS} increases. The duration of the offset interval t₁ can affect the amount of charge stored in C_{AUX} by magnetization current I_{LM} and the resulting V_{BIAS} voltage. Accordingly, the control circuit 140 can also regulate V_{BIAS} at or around V_{BIAS,REF} by setting the duration of the offset interval t₁ based on a difference between V_{BIAS} and V_{BIAS,REF}.

After the offset interval, V_{G,HV} and V_{G,LV} are de-asserted for the duration of the off-times for V_{G,HV} and V_{G,HV} (and the off-time of the power converter) related to T_{S}. Once V_{G,HV} and V_{G,LV} are de-asserted together, the magnetization current I_{LM} can flow through the parasitic capacitance of HV switch 203, which causes the parasitic charge Q_{OSS} in the parasitic capacitance of HV switch 203 to flow to C_{AUX}, and V_{BIAS} can further increase. After t₂, V_{G,HV} and V_{G,LV} stay de-asserted for the durations of the off-times of V_{G,HV} and V_{L,HV} till the end of T_{S}, and primary winding/inductor 104 can continue to discharge. At the end of T_{S}, the trailing-edge control scheme is repeated. With a trailing-edge control scheme, V_{BIAS} is generated during the t₁ and t₂ intervals, based on: 1) I_{LM} energy capture during t₁; 2) Q_{OSS} energy capture during t₂.

Depending on the target V_{BIAS}, a trailing-edge control scheme may be preferable. For example, a leading-edge control scheme can be used for a relatively low target V_{BIAS}, and a trailing-edge control scheme can be used for a relatively high target V_{BIAS}. Also, in some examples, it is possible to combine a leading-edge control scheme with a trailing-edge control scheme to generate V_{BIAS}.

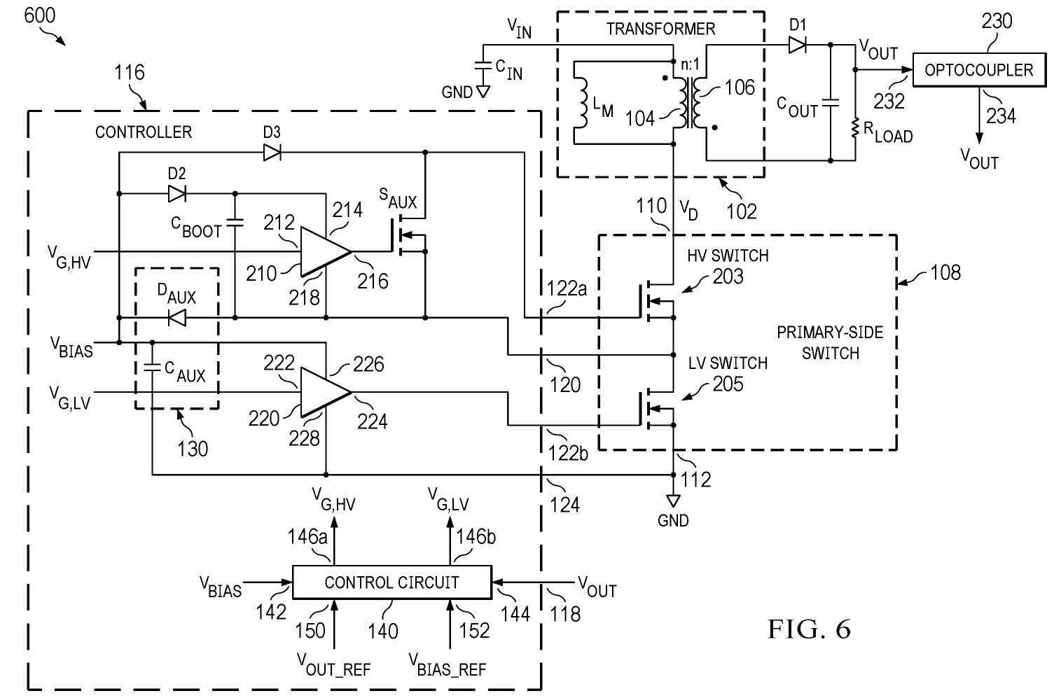

FIG. 6 is a schematic diagram showing another example power conversion system 600. In some examples, power conversion system 600 includes a flyback converter including transformer 102 and primary-side switch 108, as illustrated in FIG. 6. In some examples, power conversion system 600 includes inductor 104 and switch 108 of FIG. 1A. Also, in FIG. 6 the power source is omitted for brevity.

In FIG. 6, the controller 116 includes another diode D3 and an auxiliary switch (S_{AUX}). As shown, the anode of D3 is coupled to the first side of C_{AUX}. The cathode of D3 is coupled to the control terminal of the HV switch 203 and the first terminal of S_{AUX}. The second terminal of S_{AUX} is coupled to the second input 120 of the controller 116. The control terminal of S_{AUX} is coupled to the output 216 of the first driver circuit 210. Compared to first driver circuit 210 of FIG. 2, the first driver circuit 210 of FIG. 6 can be smaller and easier to implement. In some examples, C_{BOOT} in FIG. 6 can be smaller and/or can have a different voltage rating than C_{BOOT} in FIG. 2 since it drives switch S_{AUX} rather than HV switch 203.

In operation, the system 600 of FIG. 6 operates in a manner similar to the system 200 of FIG. 2, and the first driver circuit 210 can turn S_{AUX} on or off to control the HV switch 203. With the arrangements of FIG. 6, control of the HV switch 203 may not need a HV bootstrap and related capacitor. With the system 600, the HV switch 203 can turn on automatically through D3 responsive to the LV switch 205 being turned on. For turn off of the HV switch 203, S_{AUX} is placed between the gate and source terminals of the HV switch 203 and is driven by the first driver circuit 210 responsive to V_{G,LV}. Compared to the system 200, the first driver circuit 210 of system 600 has the benefit of being smaller and thus easier to implement relative to first driver circuit 210 of system 200.

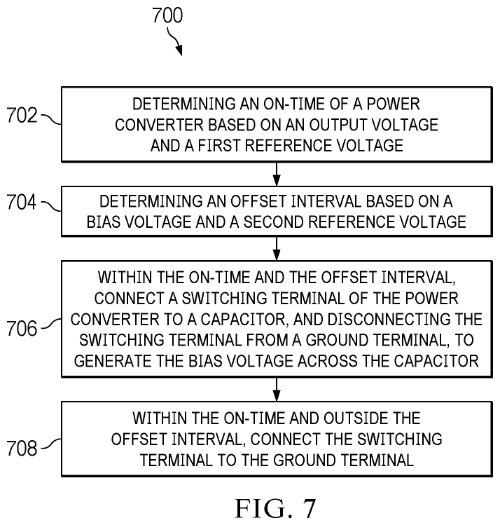

FIG. 7 illustrates a flowchart of an example method 700 of controlling a power converter, such as the example power converters described in FIGS. 1A, 1B, 2, and 6. Method 700 can be performed by, for example, control circuit 140 in conjunction with HV switch 203 and LV switch 205.

In operation 702, control circuit 140 determines the on-time of the power converter within a switching cycle (Tₛ) based on an output voltage of the power converter (V_{OUT}) and a first reference voltage, such as reference output voltage (V_{OUT_REF}). For example, referring to FIG. 3, control circuit 140 can determine a duty cycle D based on a difference between V_{OUT} and V_{OUT_REF}, and determine the on-time based on a product of D*T_{S}.

In operation 704, control circuit 140 determines an offset interval (t₁) based on a bias voltage (V_{BIAS}) and a second reference voltage, such as reference bias voltage (V_{BIAS_REF}). For example, referring to FIG. 3, control circuit 140 can determine t₁ based on a difference between V_{BIAS} and V_{BIAS_REF}. Also, in a case where a leading-edge control scheme is used, control circuit 140 can determine t₁ based on the amount of parasitic charge Qₚₐᵣ stored in the parasitic capacitance Cₚₐᵣ of the primary winding/inductor 104, and the magnetization inductor current I_{LM}. Further, in a case where a trailing-edge control scheme is used, control circuit 140 can determine t₁ based on the magnetization inductor current I_{LM}.

In operation 706, within the on-time and the offset interval, the control circuit 140 can connect a switching terminal of the power converter to a capacitor (C_{AUX}), and disconnect the switching terminal from a ground terminal, to generate the bias voltage across the capacitor. Specifically, within the on-time and within the offset interval, control circuit 140 can provide asserted control signal V_{G,HV} to enable HV switch 203, which connects the switching terminal to capacitor C_{AUX} via D_{AUX}. Also, control circuit 140 can provide deasserted control signal V_{L,HV} to disable LV switch 205, which disconnects the switching terminal from the ground terminal. In a case of leading-edge control scheme, this allows the parasitic charge Qₚₐᵣ and magnetization current I_{LM} to flow to C_{AUX} to generate V_{BIAS}. Also, in a case of trailing-edge control scheme, this allows the magnetization current I_{LM} to flow to C_{AUX} to generate V_{BIAS}. In both cases, V_{BIAS} can increase, and the difference between V_{BIAS} and V_{BIAS_REF} can be reduced.

In operation 708, within the on-time and outside the offset interval, the control circuit 140 can connect the switching terminal to the ground terminal. Specifically, control circuit 140 can provide asserted control signals V_{G,HV} and V_{L,HV} to enable HV switch 203 and LV switch 205 and connect the switching terminal to ground. This allows primary coil/inductor 104 to charge. After operation 708, control circuit 140 can dessert both control signals V_{G,HV} and V_{L,HV} to disable both HV switch 203 and LV switch 205, which allows primary coil/inductor 104 to discharge.

In some examples, a first apparatus includes a transistor (e.g., the LV switch 205 herein) coupled between a power converter bias terminal (e.g., the second input 120 herein) and a ground terminal (e.g., the second terminal 112 herein), the transistor having a control terminal. The first apparatus also includes a first driver circuit (e.g., the first driver 210 herein) having a first driver input and a first driver output; and a second driver circuit (e.g., the second driver circuit 220 herein) having a second driver input and a second driver output. The second driver output is coupled to the control terminal. The first apparatus also includes a control circuit (e.g., the control circuit 140 herein) having a control input (e.g., the first input 142), a reference input (e.g., the third input 150 herein), and first and second control outputs (e.g., the first output 146a and the second output 146b herein). The control input is coupled to the power converter bias terminal. The first control output is coupled to the first driver input. The second control output is coupled to the second driver input. In some examples, the control circuit is configured to provide first and second control signals (e.g., V_{G,HV} and V_{G,HV} herein) having a same switching frequency at the respective first and second control outputs responsive to a first voltage at the control input and a second voltage at the reference input.

In some examples, the transistor is a first transistor, and the control terminal is a first control terminal. In such examples, the first apparatus includes a first semiconductor die including the first transistor and a second semiconductor die including a second transistor (e.g., the HV switch 203 herein) having a second control terminal. The second transistor is coupled between a power converter switching terminal (e.g., the first terminal 110 herein) and the power converter bias terminal. In some examples, the control circuit is configured to set a time offset between a first transition of the first control signal and a second transition of the second control signal based on the first and second voltages.

In some examples, the control circuit is configured to: transition the first control signal between a first state (e.g., an on-state of V_{G,HV} herein) and a second state (e.g., an off-state of V_{G,HV}) within a switching cycle; and set a first duration of the first state and a second duration of the second state in the switching cycle to set a ratio between an input voltage and an output voltage of a power converter. In such examples, the second transistor is configured to be enabled responsive to the first control signal having the first state, and the second transistor is configured to be disabled responsive to the first control signal having the second state.

In some examples, the control circuit is configured to: transition the second control signal (e.g., V_{G,LV} herein) between a third state (e.g., an on-state of V_{G,LV} herein) and a fourth state (e.g., an off-state of V_{G,LV} herein) in the switching cycle; and set a third duration of the third state and a fourth duration of the fourth state in the switching cycle based on the first voltage at the control input and the second voltage at the reference input. In such examples, the first transistor (e.g., the LV switch 205 herein) is configured to be enabled responsive to the second control signal having the third state, and the second transistor is configured to be disabled responsive to the second control signal having the fourth state.

In some examples, the control circuit is configured to, within the switching cycle: transition the first control signal from the second state to the first state; and after the time offset has elapsed from the transition of the first control signal, transition the second control signal from the fourth state to the third state. In some examples, the control circuit is configured to, within the switching cycle: transition the second control signal from the third state to the fourth state; and after the time offset has elapsed from the transition of the second control signal, transition the first control signal from the first state to the second state.

In some examples, the control input of the control circuit is a first control input, the reference input is a first reference input, the control circuit has a second control input (e.g., the second input 144 herein) and a second reference input (e.g., the fourth input 152 herein). In such examples, the control circuit includes a first comparison circuit (e.g., the first comparison circuit 310 herein) having a first input, a second input, and an output. The first input of the first comparison circuit is coupled to the first control input. The second input of the first comparison circuit is coupled to the first reference input. The control circuit also includes a first compensation circuit (e.g., the first compensation circuit 320 herein) having an input and an output. The input of the first compensation circuit is coupled to the output of the first comparison circuit. The control circuit also includes a second comparison circuit (e.g., the second comparison circuit 330 herein) having a first input, a second input, and an output. The first input of the second comparison circuit is coupled to the second control input. The control circuit also includes a second compensation circuit (e.g., the second compensation circuit 340 herein) having an input and an output. The input of the second compensation circuit coupled to the output of the second comparison circuit. In such examples, the control circuit may also include a control signal generator (e.g., the on-time controller 350 herein) having a first input, a second input, a first output, and a second output. The first input of the control signal generator is coupled to the output of the first compensation circuit. The second input of the control signal generator is coupled to the output of the second compensation circuit. The first output of the control signal generator is coupled to the first control output of the control circuit. The second output of the control signal generator is coupled to the second control output of the control circuit.

In some examples, the second control input is coupled to at least one of: the switching terminal, or a power converter power output. In such examples, the first comparison circuit is configured to: compare a first voltage received at its first input with a first reference voltage received at its second input; and provide a first comparison result at its output. The second comparison circuit is configured to: compare a second voltage received at its first input with a second voltage received at its second input; and provide a second comparison result at its output.

In some examples, the first apparatus includes: a diode (e.g., D_{AUX} herein) coupled between a terminal of the transistor and the power converter bias terminal; and a capacitor (e.g., C_{AUX} herein) coupled between the power converter bias terminal and the ground terminal. In some examples, the first driver has a driver bias input, the diode is a first diode and the capacitor is a first capacitor. In such examples, the first apparatus also includes: a second diode (e.g., D2 herein) coupled between the power converter bias terminal and the driver bias input; and a second capacitor (e.g., C_{BOOT} herein) coupled between the driver bias input and the terminal of the transistor.

In some examples, the transistor is a first transistor (e.g., the LV switch 205 herein), and the control terminal is a first control terminal. In such examples, the apparatus may include: a second transistor (e.g., S_{AUX} herein) coupled between a gate drive output (e.g., output 122a herein) and the terminal of the first transistor, the second transistor having a second control terminal coupled to the first driver output; and a third diode coupled (e.g., D3 herein) between the power converter bias terminal and the gate drive output.

In some examples, a second apparatus includes: a first transistor (e.g., the HV switch 203 herein) coupled between a power converter switching terminal (e.g., the first terminal 110 herein) and a bias terminal (e.g., the second input 120 herein). The first transistor has a first control terminal. The second apparatus also includes a second transistor (e.g., the LV switch 205 herein) coupled between the bias terminal and a ground terminal (e.g., the second terminal 112 herein). The second transistor has a second control terminal. The second apparatus also includes a first driver circuit (e.g., the first driver circuit 210 herein) having a first driver input and a first driver output. The first driver output is coupled to the first control terminal. The second apparatus also includes a second driver circuit (e.g., the second driver circuit 220 herein) having a second driver input and a second driver output. The second driver output is coupled to the second control terminal. The second apparatus also includes a control circuit (e.g., the control circuit 140 herein) having a control input (e.g., the first input 142 herein), a reference input (e.g., the fourth input 152 herein), and first and second control outputs (e.g., the outputs 146 and 146b herein). The control input is coupled to the bias terminal. The first control output is coupled to the first driver input. The second control output is coupled to the second driver input. The control circuit is configured to provide first and second control signals (e.g., V_{G,HV} and V_{G,HV} herein) having a same switching frequency at the respective first and second control outputs responsive to a first voltage at the control input and a second voltage at the reference input.

In some examples, the second apparatus includes first and second semiconductor dies. In such examples, the first semiconductor die includes the first transistor, and the second semiconductor die includes the second transistor. In other examples, the second apparatus includes a semiconductor die that includes the first and second transistors. In some examples, the control circuit is configured to set a time offset between a first transition of the first control signal and a second transition of the second control signal based on the first and second voltages.

In some examples, the control circuit is configured to: transition the first control signal between a first state and a second state within a switching cycle; transition the second control signal between a third state and a fourth state in the switching cycle; and set a first duration of the first state and a second duration of the second state in the switching cycle to set a ratio between an input voltage and an output voltage of a flyback converter; and set a third duration of the third state and a fourth duration of the fourth state in the switching cycle based on the first voltage at the control input and the second voltage at the reference input. The first transistor is configured to be enabled responsive to the first control signal having the first state. The first transistor is configured to be disabled responsive to the first control signal having the second state. The second transistor is configured to be enabled responsive to the second control signal having the third state. The second transistor is configured to be disabled responsive to the second control signal having the fourth state.

In some examples, the control circuit is configured to determine a time offset based on the first and second voltages and within the switching cycle: transition the first control signal from the second state to the first state; and after the time offset has elapsed from the transition of the first control signal, transition the second control signal from the fourth state to the third state. In some examples, the control circuit is configured to determine a time offset based on the first and second voltages and within the switching cycle: transition the second control signal from the third state to the fourth state; and after the time offset has elapsed from the transition of the second control signal, transition the first control signal from the first state to the second state.

In some examples, the first state and the second state of the first control signal refer respectively to an on-state and an off-state of the first control signal. The third state and the fourth state of the second control signal refer respectively to an on-state and an off-state of the second control signal. In some examples, first and second control signals may have different voltage ranges.

In some examples, a method includes: determining an on-time of a power converter based on an output voltage (e.g., V_{OUT} herein) of the power converter and a first reference voltage (e.g., V_{OUT_REF} herein); determining an offset interval based on a bias voltage (e.g., V_{BIAS} herein) and a second reference voltage (e.g., V_{BIAS_REF} herein); within the on-time and the offset interval, connecting a switching terminal (e.g., the first terminal 110 herein) of the power converter to a capacitor (e.g., C_{AUX} herein), and disconnecting the switching terminal from a ground terminal (e.g., the second terminal 112 herein), to generate the bias voltage across the capacitor; and within the on-time and outside the offset interval, connecting the switching terminal to the ground terminal. In some examples, the offset interval is with respect to a start of the on-time. In some examples, the offset interval is with respect to an end of the on-time.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) such as an NFET or a PFET, a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control terminal and its first and second terminals. In the context of a FET, the control terminal is the gate, and the first and second terminals are the drain and source. In the context of a BJT, the control terminal is the base, and the first and second terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus comprising:
a transistor coupled between a power converter bias terminal and a ground terminal, the transistor having a control terminal;
a first driver circuit having a first driver input and a first driver output;
a second driver circuit having a second driver input and a second driver output, the second driver output coupled to the control terminal; and
a control circuit having a control input, a reference input, and first and second control outputs, the control input coupled to the power converter bias terminal, the first control output coupled to the first driver input, the second control output coupled to the second driver input, and the control circuit configured to provide first and second control signals having a same switching frequency at the respective first and second control outputs responsive to a first voltage at the control input and a second voltage at the reference input.

2. The apparatus of claim 1, wherein the transistor is a first transistor, and the control terminal is a first control terminal;
wherein the apparatus includes a first semiconductor die including the first transistor and a second semiconductor die including a second transistor having a second control terminal; and
wherein the second transistor is coupled between a power converter switching terminal and the power converter bias terminal.

3. The apparatus of claim 2, wherein the control circuit is configured to set a time offset between a first transition of the first control signal and a second transition of the second control signal based on the first and second voltages.

4. The apparatus of claim 3, wherein the control circuit is configured to:
transition the first control signal between a first state and a second state within a switching cycle; and
set a first duration of the first state and a second duration of the second state in the switching cycle to set a ratio between an input voltage and an output voltage of a power converter;
wherein the second transistor is configured to be enabled responsive to the first control signal having the first state, and the second transistor is configured to be disabled responsive to the first control signal having the second state.

5. The apparatus of claim 4, wherein the control circuit is configured to:
transition the second control signal between a third state and a fourth state in the switching cycle; and
set a third duration of the third state and a fourth duration of the fourth state in the switching cycle based on the first voltage at the control input and the second voltage at the reference input;
wherein the first transistor is configured to be enabled responsive to the second control signal having the third state, and the second transistor is configured to be disabled responsive to the second control signal having the fourth state.

6. The apparatus of claim 3, wherein the control circuit is configured to, within the switching cycle:
transition the first control signal from the second state to the first state; and
after the time offset has elapsed from the transition of the first control signal, transition the second control signal from the fourth state to the third state.

7. The apparatus of claim 3, wherein the control circuit is configured to, within the switching cycle:
transition the second control signal from the third state to the fourth state; and
after the time offset has elapsed from the transition of the second control signal, transition the first control signal from the first state to the second state.

8. The apparatus of claim 2, wherein the control input of the control circuit is a first control input, the reference input is a first reference input, the control circuit has a second control input and a second reference input, and the control circuit includes:
a first comparison circuit having a first input, a second input, and an output, the first input of the first comparison circuit coupled to the first control input, and the second input of the first comparison circuit coupled to the first reference input;
a first compensation circuit having an input and an output, the input of the first compensation circuit coupled to the output of the first comparison circuit;
a second comparison circuit having a first input, a second input, and an output, the first input of the second comparison circuit coupled to the second control input, and the second input of the second comparison circuit coupled to the second reference input;
a second compensation circuit having an input and an output, the input of the second compensation circuit coupled to the output of the second comparison circuit; and
a control signal generator having a first input, a second input, a first output, and a second output, the first input of the control signal generator coupled to the output of the first compensation circuit, the second input of the control signal generator coupled to the output of the second compensation circuit, the first output of the control signal generator coupled to the first control output of the control circuit, and the second output of the control signal generator coupled to the second control output of the control circuit.

9. The apparatus of claim 8, wherein:
the second control input is coupled to at least one of: the switching terminal, or a power converter power output;
the first comparison circuit is configured to:
compare a first voltage received at its first input with a first reference voltage received at its second input; and
provide a first comparison result at its output, and
wherein the second comparison circuit is configured to:
compare a second voltage received at its first input with a second voltage received at its second input; and
provide a second comparison result at its output.

10. The apparatus of claim 1, further comprising:
a diode coupled between a terminal of the transistor and the power converter bias terminal; and
a capacitor coupled between the power converter bias terminal and the ground terminal.

11. The apparatus of claim 10, wherein the first driver has a driver bias input, the diode is a first diode and the capacitor is a first capacitor, and the apparatus further comprises:
a second diode coupled between the power converter bias terminal and the driver bias input; and
a second capacitor coupled between the driver bias input and the terminal of the transistor.

12. The apparatus of claim 11, wherein the transistor is a first transistor, the control terminal is a first control terminal, and the apparatus further comprises:
a second transistor coupled between a gate drive output and the terminal of the first transistor, the second transistor having a second control terminal coupled to the first driver output; and
a third diode coupled between the power converter bias terminal and the gate drive output.

13. An apparatus comprising:
a first transistor coupled between a power converter switching terminal and a bias terminal, the first transistor having a first control terminal;
a second transistor coupled between the bias terminal and a ground terminal, the second transistor having a second control terminal;
a first driver circuit having a first driver input and a first driver output, the first driver output coupled to the first control terminal;
a second driver circuit having a second driver input and a second driver output, the second driver output coupled to the second control terminal; and
a control circuit having a control input, a reference input, and first and second control outputs, the control input coupled to the bias terminal, the first control output coupled to the first driver input, the second control output coupled to the second driver input, and the control circuit configured to provide first and second control signals having a same switching frequency at the respective first and second control outputs responsive to a first voltage at the control input and a second voltage at the reference input.

14. The apparatus of claim 13, further comprising first and second semiconductor dies, in which the first semiconductor die includes the first transistor, and the second semiconductor die includes the second transistor.

15. The apparatus of claim 13, wherein the control circuit is configured to set a time offset between a first transition of the first control signal and a second transition of the second control signal based on the first and second voltages.

16. The apparatus of claim 15, wherein the control circuit is configured to:
transition the first control signal between a first state and a second state within a switching cycle;
transition the second control signal between a third state and a fourth state in the switching cycle;
set a first duration of the first state and a second duration of the second state in the switching cycle to set a ratio between an input voltage and an output voltage of a flyback converter; and
set a third duration of the third state and a fourth duration of the fourth state in the switching cycle based on the first voltage at the control input and the second voltage at the reference input; and
wherein:
the first transistor is configured to be enabled responsive to the first control signal having the first state;
the first transistor is configured to be disabled responsive to the first control signal having the second state;
the second transistor is configured to be enabled responsive to the second control signal having the third state; and
the second transistor is configured to be disabled responsive to the second control signal having the fourth state.

17. The apparatus of claim 15, wherein the control circuit is configured to determine a time offset based on the first and second voltages and within the switching cycle:
transition the first control signal from the second state to the first state; and
after the time offset has elapsed from the transition of the first control signal, transition the second control signal from the fourth state to the third state.

18. The apparatus of claim 15, wherein the control circuit is configured to determine a time offset based on the first and second voltages and within the switching cycle:
transition the second control signal from the third state to the fourth state; and
after the time offset has elapsed from the transition of the second control signal, transition the first control signal from the first state to the second state.

19. The apparatus of claim 13, further comprising a semiconductor die that includes the first and second transistors.

20. A method comprising:
determining an on-time of a power converter based on an output voltage of the power converter and a first reference voltage;
determining an offset interval based on a bias voltage and a second reference voltage;
within the on-time and the offset interval, connecting a switching terminal of the power converter to a capacitor, and disconnecting the switching terminal from a ground terminal, to generate the bias voltage across the capacitor; and
within the on-time and outside the offset interval, connecting the switching terminal to the ground terminal.

21. The method of claim 19, wherein the offset interval is with respect to a start of the on-time.

22. The method of claim 19, wherein the offset interval is with respect to an end of the on-time.
